(19) United States
(12) Patent Application Publication
(10) Pub. No.: US 2016/0190860 A1
(43) Pub. Date: Jun. 30, 2016

(54) CHARGING APPARATUS AND METHODOLOGY

(71) Applicant: Joseph A. Swift, Dolgeville, NY (US)

(72) Inventor: Joseph A. Swift, Dolgeville, NY (US)

(21) Appl. No.: 14/984,003

(22) Filed: Dec. 30, 2015

Related U.S. Application Data
(60) Provisional application No. 62/098,475, filed on Dec. 31, 2014.

(51) Int. Cl. H02J 7/02; H02J 7/04

(52) U.S. Cl. CPC H02J 7/025; H02J 7/04

(57) ABSTRACT

Disclosed herein is an integrated system charging apparatus comprising a power source, an induction energy transmitting unit, and an electrical conductor; wherein, the power source, the induction energy transmitting unit, and the electrical conductor are electrically connected with each other; and wherein at least one of the electrical conductor, and the induction energy transmitting unit, further comprises an advanced composite material.

### CROSS-REFERENCE TO RELATED APPLICATIONS

This application claims priority to U.S. Provisional Patent Application Ser. No. 62/098,475 filed Dec. 31, 2014, the contents of which are incorporated by reference herein as if set forth in their entirety for all purposes as if put forth in full below.

### STATEMENT REGARDING FEDERALLY SPONSORED RESEARCH OR DEVELOPMENT

None

### THE NAMES OF THE PARTIES TO A JOINT RESEARCH AGREEMENT

None

### BACKGROUND OF THE INVENTION

Personal portable electronic devices such as cell phones, GPS receivers, laptop and tablet computers, toothbrushes, pacemakers, and power tools have become a mainstay of everyday life. It is clear that there is an ongoing proliferation of electronic equipment that requires mobile and portable power. Rechargeable and single use batteries are the presently preferred means of powering such devices. Thus, a proliferation of types and sizes of batteries is also occurring driven by the need to accommodate the specific power requirements of a vast and rapidly growing number of devices. The result is that individuals at any time may possess and employ a dozen, or more, different batteries to power the various devices used in everyday life.

The impacts of electronic device proliferation are a particular problem for the military sector where soldiers must transport and maintain a plurality of electronic devices that require battery sources. These electronic devices may include one or more; radios, GPS receivers, battlefield computers, laser target designators, flashlights, and the like. Tactical missions are becoming longer and more complex and at the same time the number of portable devices and the time the devices need to remain operational are also increasing. A solder may need to carry more than 50 batteries of various size, voltage, and current capacities and spares that in total may represent a weight of more than 20 pounds in order to accommodate the power requirements of all of the electronic devices used in a single mission. Further, the devices may be integrated within or upon an armament thereby creating a plurality of problems with the size, weight, operability and reliability of the armament.

Frequently small and large armaments are equipped with internally and/or externally attached, mounted, or connected accessories such as electric devices, electronic devices, sensors, controllers, navigation aids, navigation lights, communication devices, radar defeating signal transmitters, illumination sources, solid or fluid fueled engines, power sources, batteries, fuel cells, solar cells, and the like, as well as antennae, RFID tags, and the like. The accessories use electrical power in one or more forms and have a variety of power requirements, battery types, heat generation levels, operating specifications and failure modes. The accessories may contain their own power source in the form of batteries, battery banks, and/or power storing capacitors or super capacitors. The power sources, regardless of where they are located, either within or on the accessory or within or on the armament often take up a significant amount of space and are generally a source of considerable weight to the armament and/or accessories. Furthermore, the power sources are prone to damage or intermittent failure and generally require frequent replacement and special care and maintenance. Most batteries used for these accessories are disposable and not rechargeable, even though their indiscriminant disposal can represent an environmental, fire, safety and/or tactical hazard. The accessories may also be affixed permanently or temporarily to the armament, and often identical versions of a base armament are modified for special operations, missions, military and law enforcement departments or other end user.

The result is an assortment of armament varieties and models having a variety of accessories and attaching mechanisms which, upon integration with the armament and the various power sources, create a complex and heavy and/or bulky armament system. As the military's demand increases for more, and more complex, accessories and as the number of accessories mounted to or on the armament increases, along with the various power sources the combined weight makes the armament complex and heavy and affects the balance, cost, accuracy, reliability, and performance all of which places a serious burden, not only on the soldier, but on the entire military infrastructure as well.

The need to replace power sources also creates a need to store or dispose of the used batteries creating a situation where the armament bearer must carry used batteries or leave the batteries in the field of operations causing a potential environmental hazard, safety, and tactical hazard.

Hence, there is a need to reduce the weight and variety of batteries required to power the vast and increasing number of electronic devices, not only in the military sector, but in various civilian sectors as well.

The solution to the problem is to have an apparatus where the device or armament and/or accessory has on or within it a means for receiving power wirelessly to which the power requiring devices can be coupled to a portable power providing apparatus allowing the individual device batteries to be either eliminated or integrated into a critical few in number. Fewer and/or smaller batteries, particularly when they can be located within a central location or distributed to a plurality of convenient locations, can also contribute to greater load carrying capacity of the armaments and free the user to carry other necessities or to minimize weight carried by the user to lessen user fatigue.

If the solution to the multitude of batteries is to eliminate or consolidate individual batteries the power using devices will still need a source of reliable remote power. The remote source of power is preferably personally portable and provides a wireless method of directly powering the devices and/or recharging batteries when in the field or when the device is in use. The solution requires placing the portable source of power referred to herein in part as a transmitting member, and a power receiving system on or near the armament bearer. Incorporating the wireless charging mechanism into garments worn by the armament bearer or into personally portable containers provides a way to overcome the need to carry a large number of batteries. Examples of garments include: coats, hats, gloves, vests, sleeves, and the like, as well as the pockets of such items. Examples of personally portable containers include: holsters, backpacks, bags, and the like. In effect, the items worn or carried by the armament bearer become the power source for the armament, armament accessories and/or other devices. Incorporating the wireless charging mechanism into garments worn by the armament bearer, or into other wearable items enables a more optimum location for the power source to reside and enables a better balance of the loads that the soldier must carry.

patent application Ser. No. 13/999,054 filed Jan. 8, 2014, the contents of which are incorporated by reference herein as if set forth in its' entirety, generically discloses apparatus having management of electrical power capacity regions and management of thermal capacity regions.

patent application Ser. No. 14/447,822 filed Jul. 31, 2014, the contents of which are incorporated by reference herein as if set forth in its' entirety, generically discloses composite interconnect accessory rail system.

Provisional Patent Application Ser. No. 62/085,519, filed Dec. 1, 2014, the contents of which are incorporated by reference herein as if set forth in its' entirety, generically discloses armament with wireless charging apparatus and methodology.

patent application Ser. No. 14/955,642 filed Dec. 1, 2015, the contents of which are incorporated by reference herein as if set forth in their entirety for all purposes as if put forth in full below, generically discloses armament with wireless charging apparatus and methodology.

U.S. Pat. No. 8,853,891, granted Oct. 7, 2014, the contents of which are incorporated by reference herein as if set forth in its' entirety, generically disclosed inductive body armor.

The publication; Military Standard: Dimensioning of Accessory Mounting Rail for Small Arms Weapons, AMSC, 3 Feb. 1995; establishes standard methods of dimensioning accessory mounting rails for small arms weapon systems. It also establishes uniform accessory mounting rails and requirements that are interchangeable among the different units of the U.S. Defense Department.

### SUMMARY

Disclosed herein is an integrated system charging apparatus comprising a power source, an induction energy transmitting unit, and an electrical conductor; wherein, the power source, the induction energy transmitting unit, and the electrical conductor are electrically connected with each other; and wherein at least one of the electrical conductor, and the induction energy transmitting unit, further comprises an advanced composite material.

Further disclosed herein is an integrated system charging apparatus comprising a power source, an induction energy transmitting unit, and an electrical conductor; wherein the power source, the induction energy transmitting unit, and the electrical conductor are interconnected, and wherein the induction energy transmitting unit further comprises a primary induction member; wherein at least one of the electrical conductor, the induction energy transmitting unit, and the primary induction member further comprises an advanced composite material; wherein the advanced composite material comprises at least two regions; and wherein a first region of the advanced composite material is selected from the group consisting of an advanced composite material forming an electrical power management region, an advanced composite material forming an electrical power management sub-region, an advanced composite material forming an electrical power management micro-domain and combinations thereof; and at least a second region of the advanced composite material is selected from the group consisting of an advanced composite material forming a thermal power management region, an advanced composite material forming a thermal power management sub-region, an advanced composite material forming a thermal power management micro-domain and combinations thereof; which in combination provides the integrated system charging apparatus.

Further disclosed herein is a method of wirelessly providing energy to an induction chargeable armament, the method comprising providing at least one induction chargeable armament capable of receiving an inductive charge; providing at least one integrated system charging apparatus capable of creating an inductive charge; bringing the induction chargeable armament and the integrated system charging apparatus into proximity with each other, such that the inductive charge flows from the integrated system charging apparatus to the induction chargeable armament.

### BRIEF DESCRIPTION OF THE DRAWINGS

FIG. 1 is an integrated system charging apparatus shown as an induction coil, interconnecting electronics, and electrical connectors providing a configuration that is capable of wireless, non-contact inductive power transfer to a receiving induction energy-using device.

### DETAILED DESCRIPTION

Before explaining some embodiments of the present invention in detail, it is to be understood that the invention is not limited in its application to the details of any particular embodiment shown or discussed herein since the invention comprises still further embodiments, as described by the granted claims.

The terminology used herein is for the purpose of description and not of limitation. Further, although certain methods are described with reference to certain steps that are presented herein in a certain order, in many instances, these steps may be performed in any order as may be appreciated by one skilled in the art, and the methods are not limited to the particular arrangement of steps disclosed herein.

As utilized herein, the following terms and expressions will be understood as follows:

The terms “a” or “an” are intended to be singular or plural, depending upon the context of use.

The term “about” as utilized herein refers to the statistically average variability as is typically found in the art of the invention herein.

The expression “accessibly embedded contact surface” refers to a substrate, region, sub-region, or micro-domain of an electrically and/or thermally conductive material encased within a second material to enable contact to be made between at least a portion of the embedded electrical and/or thermal conductor, i.e., the interconnect, and an external contact substrate to complete an electrical and/or thermal circuit.

The term “accessory” refers to any device requiring electrical power capable of connecting directly or indirectly to an armament power source.

The term “advanced” refers to a system or material that due to its composition, design, or use is at, or performs at, a level that is above a generally accepted norm or base of comparison. In some instances it refers to a higher level of complexity when compared to common or contemporary systems, materials, methods, or ideas.

The expression “advanced armaments system” means any armament or projectile propelling apparatus comprising at least one advanced composite material.

The expression “advanced composite” means a material capable of replacing metals, and created by combining reinforcement filler with a compatible host system. The advanced composite may be in any form, e.g., a rigid solid, a semi-rigid solid or a flexible solid, an elastomer, a prepreg, and the like.

The expression “advanced composite material” refers to a composition of matter comprised of a matrix material and at least one fibrous filler material. Typically, the fibrous filler works in concert with the matrix to provide or contribute to a critical property of the composite. Examples of such critical properties include high strength, high stiffness, and high modulus of elasticity, electrical conductivity, thermal conductivity, and low specific density when compared to other common materials. Examples of matrix materials may include: polymers, ceramics, glasses, cements, metals as well as blends and combinations thereof. Examples of fibrous filler materials include: carbon fiber(s), carbon nanotubes, fiberglass, metal fibers, fine metal filaments, polymeric fibers including fine polymeric fibers, mineral fibers, basalt fibers, metalized carbon fibers, metalized carbon nanotubes, metalized glass, metalized basalt, metalized mineral fibers, natural fibers, metalized natural fibers, composite fibers, and mixtures and combinations thereof. The fibrous filler materials may include: solid fibers, hollow fibers, bi component fibers, multicomponent fibers, single or multilayered fibers and may be of any size, shape, or geometric configuration, and may have any surface topography and may be rigid, semi rigid, flexible, elastic, or porous and combinations thereof.

The expression “advanced composite structure” means a physical member comprised of at least one advanced composite material.

The term “armaments” as utilized herein refers to arms, defensive equipment, offensive equipment, weapons, guns, munitions, ordnance, explosives, missiles, torpedoes, shells, bombs, grenades, firearms, pistols, rifles, revolvers, shotguns, grenade launchers, rocket launchers, projectile-firing systems, projectile-propelling systems, weapons-firing systems, rockets, vehicles, land vehicles, ships, aircrafts, spacecraft, and any combinations of the above. An armament may also be an accessory to another armament. Armaments may also include items for which a military, police, or sports-persons are equipped, including: helmets, shields, back packs, body armor, and the like. Specific examples of common rifles, shotguns, and small weapons include but are not limited to: AR-15, M-16 and M-5 types, Remington® 870, Beretta® 92, Colt® 1911 and Glock® 17 styles and the like. Specific examples of common large weapons include but are not limited to: personnel shoulder-launched missiles and rockets, smart bombs, laser guided bombs, and any related motion-capable large explosive apparatus using internal or remote electrical power.

The expression “armament component” refers to any of the parts which comprise an armament. For example, on small arms, this may refer to but is not limited to, butts, grips, or barrels.

The term “controller” as utilized herein is an object capable of receiving and/or transmitting electrical and/or thermal energies and shall mean a circuit member capable of at least one of sensing, measuring, or modulating an electrical and/or thermal energy.

The expression “critical property” refers to at least one physical, mechanical, electrical, or thermal property of a composite that enables the advanced composite material to provide the desired functionality when used in a specific application.

The expression “electrical conductor” means a wire, cable, or similar object capable of conducting an electrical charge.

The expression “electrical contact” refers to one-half of a contact pair consisting of an electrically conductive surface that may be electrically connected to at least one second electrical contact to form a circuit to permit flow of electrical current.

The expression “electrical conduit” refers to a pathway in, through and/or around a conductive material that is capable of conveying current or transporting electrical or electrostatic charge.

The expressions “electrical interconnect” or “electrical interconnection,” refers to physical contact or near contact between two or more electrical conduits enabling passage of current or transport of charge(s). In certain instances, it refers to the interface substrate between two, or more electrical conduits.

The expression “electrically insulating” means an electrically resistive material having a high effective electrical resistance, for example having a d.c. volume resistivity in the range greater than about 10⁶ ohm-m and having a capability to prevent the flow of current in one, or more parts of the circuit or between adjacent circuits.

The expression “electrical power management” shall be understood to be a characteristic of the advanced composite material where the advanced composite material has regions for electrical conduction and regions for electrical insulation and where electrical power transmission can be managed using the electrical conduction and insulation properties of the advanced composite material.

The term “garment” refers to anything that can be worn by a person including but not limited to clothing, armor, foot-coverings, head-coverings, protective-wear, or other wearable items. Examples of garments include: coats, hats, gloves, vests, sleeves, and the like, as well as the pockets of such items. Examples of personally portable containers include: holsters, backpacks, bags, and the like.

The terms “induction” or “inductive” when used in conjunction within an expression shall be understood to encompass both magnetic induction and magnetic resonance.

The expression and term “induction coil” or “coil” shall refer to a conductive material which is wound one or more times or otherwise shaped, molded, printed, electroformed, plated, or configured to form a spiral, a generally circular pattern, or similar form. Typically the coil will have at least two contact regions generally located at the coil end regions where connection to an electrical circuit can be made to enable power to be provided to a power using accessory or to accept power from a power source. In order to achieve a high desired level of wireless inductive charging performance the material may be wound at least two times around a suitable core material, wherein the core is made of any suitable solid, liquid, gaseous, or intermediate material.

The expression “induction chargeable armament” shall be understood to be any armament, with or without accessories, which may receive an inductive energy from an induction charging device.

The expressions “induction grid” or “grid” shall refer to conductive material which is configured in a 2-dimension or 3-dimension geometric pattern where the material has at least two terminal ends of the conductive material for a continuous electric circuit. The grid may be fabricated into a sheet form by any suitable process such as hand lay-up, casting, knitting, weaving, braiding, and the like. The term “grid”, when referred to as “integrated grid”, refers to an assembly of coils and/or loops that are configured into a network where power transfer can occur at one, or more, positions across or within the network.

The expressions “induction loop” or “loop’ shall refer to conductive material which is formed in a general pattern having any geometric shape, such as a generally circular pattern, an elongated oval, a square-shape, a rectangular shape, a triangular shape and the like.

The expression “induction member” shall refer to an induction coil, induction loop, induction grid, or combinations thereof.

The expression “induction energy transmitting unit” shall refer to a transmitter circuit comprising an induction member, a power management controller and a thermal management controller.

The term “integrated” refers to a structural system which is organized so that constituent units function cooperatively.

The expression “integrated system” refers to an apparatus wherein the component parts, either on or within a structural feature are organized so that the parts are capable of functioning cooperatively.

The expression “integrated system armament” refers to an armament wherein the armament accessories and the armament function cooperatively and are capable of being charged by induction. This includes an advanced armament system. An example of such an integrated armament system is described in patent application Ser. No. 14/955,642 filed Dec. 1, 2015.

The expression “integrated structural system” means two or more structural features combined into a unit. In preferred embodiments, the combination of two or more advanced composites creates an enhancement to, or synergy between one or more critical properties such as mechanical strength, impact resistance, abrasion resistance, modulus of elasticity, electrical conductivity, thermal conductivity, and relative density, and the like.

The expression “managing electrical energy” means the control of movement, removal, storage, or regulation of electrical energy.

The expression “managing thermal energy” means the control of movement, removal, storage or regulation of thermal energy.

The expression “micro-domain” refers to any relatively small region that has a distinct structure and a distinct function.

The term “polymer” includes, but is not limited to any organic molecule or large molecule made up of chains or rings of linked monomer units including, but not limited to: polyurethane, nylon, polyester, polyimide, epoxy, silicone, fluoropolymers, as well as copolymers, blends and mixtures thereof.

The expression “power source” shall include any source of electrical power, including but not limited to, batteries, battery banks, power storing capacitors, super capacitors, fuel cells, solar cells, generators, portable generators, electrical outlets, and the like.

The expression “personally portable” includes that which can be carried by a person or by a person with minimal aid, such as but not limited to, with the aid of a service animal or carrying device.

The expression “personally portable container” is a carrying device which partially or fully encloses a personally portable object or device and aids in making the object or device personally portable. A personally portable container may itself be hand-held, wearable, or a combination thereof.

The term “region” as utilized herein is the functional portion of the advanced systems armament with a defined separate response to the functional requirements and/or stimulus.

The term “reinforcing” refers to the effect of one material when combined with at least one second material that results in strengthening, fortification, and/or improvement of at least one characteristic or property of the material or the combination of materials.

The term “substrate” refers to a base layer or a layer that is underneath a subsequent layer. It can also refer to a surface onto which a second material such as a coating, a finish, a paint, a catalyst, a metal layer, insulating layer, or combinations thereof which is applied.

The expression “thermal conductor” refers to any material that conveys or conducts heat.

The expression “thermal conduits” refers to any material that conveys or conducts heat.

The term “thermal contact” refers to one-half of a contact pair consisting of an electrically or thermally conductive surface that may be thermally connected to at least one second thermal contact to form a circuit to permit flow of electrical and/or thermal energy.

The expressions “thermal interconnect” and “thermal interconnection” refer to the physical contact or near contact between two, or more thermal conduits that enables passage of heat. In certain instances, they refer to the interface region between two, or more thermal conduits.

The expression “thermal power management” shall be understood to be a characteristic of the advanced composite material where the advanced composite material has regions for thermal conduction and regions for thermal insulation and where thermal energy transmission can be controlled using the thermal conduction and insulation properties of the advanced composite material.

The present invention may be an integrated system charging apparatus comprising a power source, an induction energy transmitting unit, and an electrical conductor; wherein the power source, the induction energy transmitting unit, and the electrical conductor are interconnected; and wherein at least one of the electrical conductor, and the induction energy transmitting unit, further comprises an advanced composite material.

The integrated system charging apparatus may further be personally portable.

The integrated system charging apparatus may further comprises a garment and the garment may further comprise an advanced composite material.

The integrated system charging apparatus may further comprise an induction chargeable armament.

In a further embodiment, the present invention may be an integrated system charging apparatus comprising at a power source, an induction energy transmitting unit, and an electrical conductor; wherein the power source, the induction energy transmitting unit, and the electrical conductor are interconnected; and wherein the induction energy transmitting unit further comprises a primary induction member; wherein at least one of the electrical conductor, the induction energy transmitting unit, and the primary induction member further comprises an advanced composite material; wherein the advanced composite material comprises at least two regions; and wherein a first region of the advanced composite material is selected from the group consisting of an advanced composite material forming an electrical power management region, an advanced composite material forming an electrical power management sub-region, an advanced composite material forming an electrical power management micro-domain and combinations thereof; and at least a second region of the advanced composite material is selected from the group consisting of an advanced composite material forming a thermal power management region, an advanced composite material forming a thermal power management sub-region, an advanced composite material forming a thermal power management micro-domain and combinations thereof; which in combination provides the integrated system charging apparatus.

The integrated system charging apparatus may further have an induction energy transmitting unit further comprising a housing and the housing comprises an advanced composite material.

The integrated system charging apparatus may further be personally portable.

The integrated system charging apparatus may comprise a garment or a personally portable container (115).

The integrated system charging apparatus may further be the garment or the personally portable container (115) and may further comprise an advanced composite material.

The integrated system charging apparatus may further comprise an induction chargeable armament.

The integrated system charging apparatus may further comprise an integrated system armament.

In yet a further embodiment the present invention may provide a method of wirelessly providing energy to an induction chargeable armament, the method comprising: providing at least one induction chargeable armament capable of receiving an inductive charge; providing at least one integrated system charging apparatus capable of creating an inductive charge; bringing the induction chargeable armament and the integrated system charging apparatus into proximity with each other, such that the inductive charge flows from the integrated system charging apparatus to the induction chargeable armament.

The method of wirelessly providing energy may further provide that the integrated system charging apparatus capable of creating an inductive charge is personally portable.

The method of wirelessly providing energy may further provide that the integrated system charging apparatus capable of creating an inductive charge is a garment.

The method of wirelessly providing energy may further provide that a secondary induction member is in magnetic flux with a magnetic field proximal to a primary induction member.

The method of wirelessly providing energy may further provide that an induction energy transmitting unit of the integrated system charging apparatus may be manually activated to provide energy to an induction energy receiving unit, independent of the electromagnetic field geometry between the primary induction member and the secondary induction member.

The method of wirelessly providing energy may further provide that an induction energy transmitting unit of the integrated system charging apparatus automatically establish a connection between the induction energy transmitting unit and the induction energy receiving unit; and the method further providing that energy be directed between the primary induction member and the secondary induction member.

The invention herein will be better understood by reference to the figures wherein like reference numbers refer to like components.

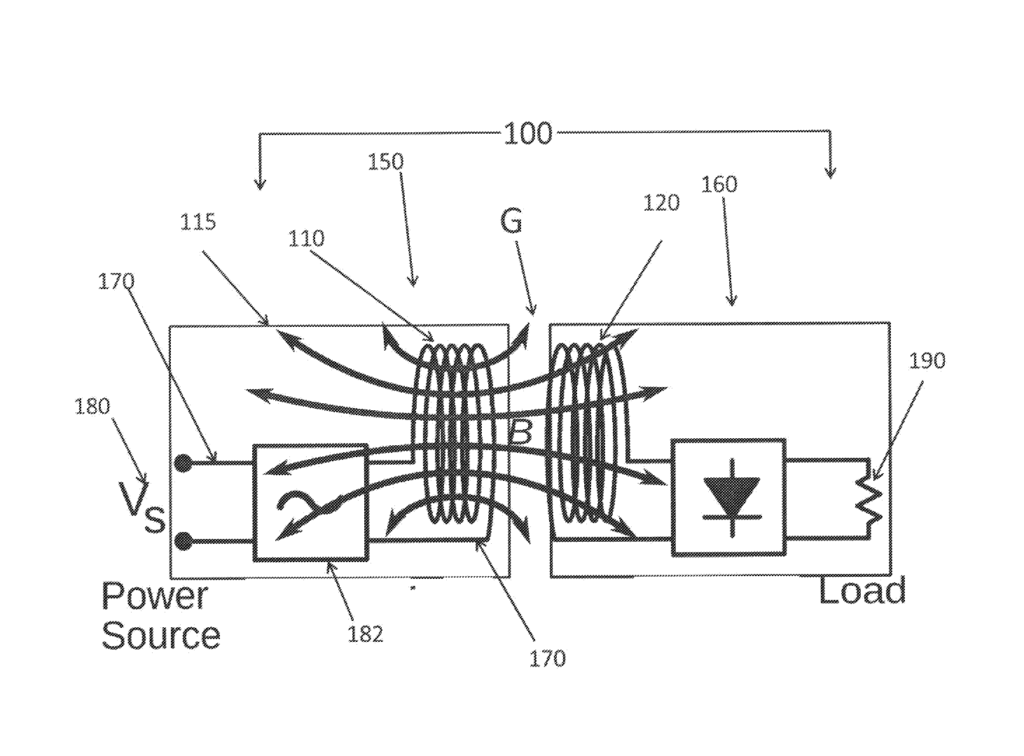

FIG. 1 illustrates an integrated system charging apparatus (100) having an induction energy transmitting unit (150) and an induction energy receiving unit (160). The primary induction member (110) and secondary induction member (120), interconnecting electronics (182), and conductive interconnections (170) provide a configuration that is capable of wireless, non-contact inductive power transfer between a power source (180) and a power utilizing load (190) and further comprises an induction energy transmitting unit (150) and an associated induction energy receiving unit (160). The induction energy transmitting unit (150) comprises a primary induction member, (110) and the induction energy receiving unit (160) comprises a secondary induction member (120). In certain embodiments the primary and secondary induction members are configured into the form of a generally circular coil member comprised of several or more winding layers of thin, electrically conductive, magnetically susceptible wire, such as that of copper, copper coated carbon fiber, nickel, nickel coated carbon fiber, copper or nickel coated fiberglass or other suitable substrate fiber, or as multiplicity of fibers such as stainless steel filaments, copper strands, and the like. The primary induction member (110) in certain embodiments is configured as a generally circular electromagnetically active region in combination with an electrical conductor (170), interconnecting electronics (182) which may serve as a power controller and connections (170) to a power source (180), upon passing of an electric current through the primary induction member (110) an electromagnetic field is generated (B) that enables a secondary induction member (120) to receive power which in turn can be supplied to a load device (190). Thus the induction energy transmitting unit (150) may be used to wirelessly transmit power to a suitable induction energy receiving unit (160) to comprise the basic elements of an integrated system charging apparatus.

The primary induction member (110) is formed from any suitable material that can create an electromagnetic field (B) when coupled to or powered by a power source (180). The primary induction member (110) may be formed as a single loop (Not shown) or into a plurality of loops as generally illustrated in FIG. 1, or from any number of overlapping or under lapping or side lapping loops in a generally circular configuration or in the form of a grid. The principles of non-contact electromagnetic power transfer, i.e. induction, are well known. In general, the more loops that are used to create the wireless electromagnetic field, and the finer (i.e. higher gauge) the primary induction member (110) material, the more it is able to efficiently create the electromagnetic field (B). In general, the higher the level of electromagnetic field (B) created by the primary induction member (110) for any applied power level, the higher levels of power enabled to be transmitted across an inter-coil gap (G). Owing to the fact that as much as 20-50% of the energy so transmitted is converted into wasted thermal energy, provisions must be made to accommodate the generation of the unwanted heat. The effective power transmission distance may be defined as the maximal inter-coil gap (G) where through an acceptable level of power may be conveyed. In some cases the inter-coil gap (G) may exceed a distance of 25 mm or more. In the case where the primary induction member (110) comprises multiple adjacent metal wire loops or circles, a suitable electrically insulating material is generally used to isolate each loop from its nearby neighboring loops or layers of loops that comprise the transmitting unit.

A non-limiting embodiment of the present invention may be a multi-component, integrated system comprising at least one power source (180), at least one induction energy transmitting unit (150), and at least one conductor (170) where the integrated system is electrically connected. The induction energy transmitting unit comprises (150) at least one induction member, known as the primary induction member (110). An advanced composite material may be part of the integrated system and may comprise the conductors and other the components of the induction power transmitting unit (150). The primary induction member (110) may be composed of the advanced composite material.

The advanced composite material may contain at least two regions, sub-regions, and/or micro-domains wherein each is adapted to control, influence, and/or regulate at least one critical property. Examples of such critical properties include strength, stiffness, modulus of elasticity, electrical conductivity, thermal conductivity, and relative density when compared to other common materials. Examples of matrix materials may include: polymers, ceramics, glasses, cements, metals as well as blends and combinations thereof. Examples of fibrous filler materials include: carbon fiber(s), carbon nanotubes, carbon shards, fiberglass, metal fibers, fine metal filaments, metal shards, polymeric fibers including fine polymeric fibers, mineral fibers, basalt fibers, metalized carbon fibers, metalized carbon nanotubes, metalized glass, metalized basalt, metalized mineral fibers, natural fibers, metalized natural fibers, and mixtures and combinations thereof. Examples of particle fillers include: carbon black, aluminum flakes, nickel flakes, metal-, or metal oxide particles, and any size or shape material in powder form that may be combined with a matrix material to form an advanced composite material.

The advanced composite material may be woven into a fabric incorporating or integrating the apparatus with a garment worn by a person. Such garments would include but not be limited to gloves, shirts, sleeves, gauntlets, jackets, vests, coats, pants, hats, scarves, or any wearable item, and combinations thereof. The pockets of such garments or the spaces between fabric layers of such garments may also be locations where the apparatus may be incorporated or integrated. The apparatus integrated with a garment would be portable and capable of moving with the user.

The advanced composite material may be woven into a fabric thereby creating an advanced composite structure by incorporating or integrating the apparatus within a personally portable container (115). Such containers would include bags, backpacks, handbags, brief-cases, suit-cases, saddle-bags, or the like. The apparatus incorporated or integrated within a personally portable container (115) would be capable of moving with the user.

The induction energy transmitting unit (150) may connect to an induction power receiving unit (160). The primary induction member (110), which is part of the induction energy transmitting unit, and a secondary induction member (120), which is part of an induction power receiving unit, are capable of inductively coupling. The coupling may be the result of direct contact or near proximity non-contact between the primary induction member (110) and the secondary induction member (120). The coupling may also be the result of the secondary induction member being in a planar or non-planar orientation within the magnetic field of the primary induction member.

The induction energy transmitting unit (150) may comprise the entire garment or personally portable container (115). The advanced composite material allows for a grid of induction coils to be placed throughout the garment or personally portable container (115). Thus any device or armament that can be charged via induction can be charged by being in contact or within proximity of the magnetic field being generated by the garment or personally portable container (115).

Since a garment or personally portable container (115) may effectively be a charging source for inductively chargeable devices or armaments, a device may be charged regardless of the efficiency of power transfer.

One example of such an embodiment may be an induction energy transmitting unit woven into the fabric of a garment. The garment, the induction energy transmitting device, the primary induction member, and the conductor are all made from an advanced composite material. Electrical current is transmitted from the battery to the induction energy transmitting unit, to the primary induction member. The garment wearer can come into proximity of or grip an inductively chargeable armament or any inductively chargeable device, and thereby transmit inductive energy from the garment to such armament or device. Heat generated from such a connection is moved along thermal conduits within the advanced composite material of the garment to a region of need or to a region where heat may be dissipated.

The invention herein allows for designs which take advantage of available space within and around commercially available or custom made garments. The induction power transmitting unit can be incorporated within or placed on or within these garments.

Induction members may be wound in a self-supported configuration, i.e., they may be wound around a solid core, they may be supported by a substrate, or they may be integrated into an advanced composite material to form an advanced composite structure. If the coils are self-supported, the coils can be contained in a gaseous environment, having a gaseous core. The most common gaseous core is an air core.

The induction members may be made from an electrically conductive material incorporated in an advanced composite material but the induction members can also be made from the advanced composite material to take advantage of the conductive and additional thermal properties of the advanced composite material. Embodiments of the invention herein may be metal coils or loops or grids solidified or semi-solidified within a host polymer to form an integrated structural system.

Electronic power transmission, regulation, and detection in transmitting members may comprise at least one of a detection device for signal frequency, a voltage to frequency converter, as well as other sensor, or display, and/or power regulation devices so that the receiving member will know to accept the connection, initiate and sustain power transfer, and charge and/or power induction energy receiving device. The electronics which are ultimately used to initiate and regulate inductive power transfer will depend on the end-use apparatus and intended application.

Referring to armaments, there are commercially available small arms and large arms designs and components such as butt stocks, rails, grips, housings, and similar members. The secondary induction member (120) may be on or integrated into the armament or its components. The induction power transmitting unit can be in compliant contact with or placed in nearby proximity to these components including or modified to include a suitable power receiving apparatus.

The presence of a power storage device or battery within the power receiving apparatus will vary with the type of application and/or armament design and depending upon the immediate need for power by the power utilizing component(s) may not need to have a continuous source of power. In this event, the induction energy transmitting unit (150) may have a microprocessor type device to control when power may be required and/or to enable the induction energy transmitting unit (150) to enter or sustain a rest or sleep period of non-use and thereby improve the overall efficiency of power usage. Alternatively, the integrated system charging apparatus (100) user may wish to manually turn on power transmission so that a sustained induction energy transmission may take place.

The primary induction member(s), any conductors connected to the power storage device or connected to the induction energy transmitting unit, or within the induction energy transmitting unit, and any of the materials surrounding, containing, or supporting these components, may be made from one or more advanced composite material.

The inductive system charging apparatus (100) may be connected to, or integrated within, a second integrated, multi-component, multifunctional integrated structure wherein at least one first element comprising an electrically conductive composite having managed thermal properties is combined, with a second structural feature having managed thermal and electrical properties to form an integrated system charging apparatus of any size. The first element is preferably electrically conductive throughout or upon or within selected regions and may consist of an intrinsically conductive polymer or a host polymer containing electrically conductive fibers, powders, flakes, shards, or other electrically conducting fillers or a conductive composite or filler having an adapted metal layer applied thereto. The first element may be adapted for conducting power and/or a signal between one location and a second.

In addition, the first element may have managed thermal properties and would therefore be thermally conductive, semiconductive or insulating; depending upon the requirements of the specific application. In some embodiments the first element serves to provide the ability to move, remove, and/or store heat which may be generated by charging an induction chargeable device or by operation of the electric circuit and thereby serves to manage and/or regulate local temperatures within the integrated system charging apparatus. In preferred embodiments the first element is tolerant of high temperatures.

When in combination with a second structural feature that is electrically insulative and having managed thermal properties, the integrated system charging apparatus serves as a power source for inductively chargeable devices, including induction chargeable armaments. More than one first element and second feature may be combined to form a large structure and may contain one or more accessibly embedded contact surface regions and/or embedded coils. Moreover, the second structural feature may be electrically insulative but thermally conductive which permits enhanced external cooling of portions of the integrated system charging apparatus. Since during operation the charging induction member may generate a significant amount of heat, it may be integrated directly into the second structural feature wherein heat generated by the inductive charging process can be appropriately managed. Optionally, portions of the external surface of the integrated system charging apparatus may have macroscopic surface components, such as fins, louvers, gratings, ports, holes, slots, struts, threaded, clamp-type fastening sites and the like, or microscopic surface components, e.g., a micro-roughness, mixed surface composition, colorants, or modified surface energy which may assist in heat dissipation. Also, optionally, the structure may comprise one or more sub-regions or micro-domains having accessibly embedded contact surface regions that provide for electric or thermal interconnection. In preferred embodiments, the second and other constituent elements are tolerant of high temperatures.

The first element may be integrated within or upon the second feature to form an advanced composite structure and serves to conduct signal or power, adapted to activate, monitor, display, control, or energize a device in proximity of or in contact with the advanced composite structure.

The first element may be integrated within or upon the second feature to form a conductor and serve to conduct signal or power adapted to activate, monitor, control, or energize an accessory or armament that is appropriately in the proximity of or in contact with the advanced composite structure.

An inductive power transmitting unit may be incorporated in a suitable host polymer to form an advanced composite structure having wireless power transmitting capabilities.

Likewise, contact(s) made between two or more thermally conducting members where heat movement across a point of interconnection is desirable may be configured in a similar fashion such that guidelines for establishing reliable electrical interconnects also apply to establishing thermal interconnects.

The electrical interconnect, when formed by two contacts, may be permanent or temporary. Thus, the integration of the first element and second feature into a single multicomponent integrated system charging apparatus having the above-described contact interconnects provides a means to activate, interrogate (sense), or energize an inductively chargeable device or a chargeable device connected to an inductively chargeable armament.

An embodiment may include an integrated system charging apparatus having an advanced composite material, wherein the integrated system charging apparatus further comprises at least two regions; and wherein a first region of the integrated system charging apparatus has a property selected from the group consisting of strength, stiffness, modulus of elasticity, electrical conductivity, thermal conductivity, specific density, and combinations thereof; and, at least one second region of the integrated system charging apparatus has a property selected from the group consisting of strength, stiffness, modulus of elasticity, electrical conductivity, thermal conductivity, specific density, and combinations thereof which is different than the property of the first region.

The integrated system charging apparatus may further have a power source, an induction energy transmitting unit, and an electrical conductor; wherein the power source, the induction energy transmitting unit, and the electrical conductor are electrically connected with each other.

The integrated system charging apparatus may be personally portable. The integrated system charging apparatus may also be a garment. The garment may comprise an advanced composite material.

The integrated system charging apparatus may further comprise an induction chargeable armament.

In a further embodiment, present invention may be an integrated system charging apparatus comprising at a power source, an induction energy transmitting unit, and an electrical conductor; wherein the power source, the induction energy transmitting unit, and the electrical conductor are interconnected; and wherein the induction energy transmitting unit further comprises a primary induction member; wherein at least one of the electrical conductor, the induction energy transmitting unit, and the primary induction member further comprises an advanced composite material; wherein the advanced composite material comprises at least two regions; and wherein a first region of the advanced composite material has a property selected from the group consisting of strength, stiffness, modulus of elasticity, electrical conductivity, thermal conductivity, specific density, and combinations thereof, and, at least a second region having a property selected from the group consisting of strength, stiffness, modulus of elasticity, electrical conductivity, thermal conductivity, specific density, and combinations thereof, which in combination provides the integrated system charging apparatus.

The integrated system charging apparatus may further comprise an electrical conductor consisting of an advanced composite material which may be an advanced composite material forming an electrical power management region, an advanced composite material forming an electrical power management sub-region, an advanced composite material forming an electrical power management micro-domain, or combinations thereof and further wherein at least one of the advanced composite material forming electrical conductor(s) further comprises a thermal power management component which may have thermal power management region, a thermal power management sub-region, a thermal power management micro-domain or combinations thereof.

The integrated system charging apparatus may have a housing for the induction energy transmitting unit and that housing may comprise an advanced composite material.

The integrated system charging apparatus may be personally portable.

The integrated system charging apparatus may comprise a personally portable container (115) and the personally portable container (115) may be an advanced composite material comprising at least two regions. A first region of the advanced composite material may have a property selected from the group consisting of strength, stiffness, modulus of elasticity, electrical conductivity, thermal conductivity, specific density and combinations thereof; and at least a second region having a property selected from the group consisting of strength, stiffness, modulus of elasticity, electrical conductivity, thermal conductivity, specific density, and combinations thereof, which envelops the induction energy transmitting unit.

The integrated system charging apparatus may further comprise a garment. The garment may comprise an advanced composite material having at least two regions. A first region of the advanced composite material may have a property selected from the group consisting of strength, stiffness, modulus of elasticity, electrical conductivity, thermal conductivity, specific density and combinations thereof and at least a second region having a property selected from the group consisting of strength, stiffness, modulus of elasticity, electrical conductivity, thermal conductivity, specific density, and combinations thereof, which envelops the induction energy transmitting unit.

The integrated system charging apparatus may further comprise an induction chargeable armament and the armament may be an integrated system armament.

An example of wirelessly providing energy to an induction chargeable armament capable of receiving an inductive charge using an integrated system charging apparatus capable of creating an inductive charge, may comprise: having at least one induction chargeable armament capable of receiving an inductive charge; providing at least one integrated system charging apparatus capable of creating an inductive charge; bringing the induction chargeable armament and the integrated system charging apparatus into proximity with each other, such that the inductive charge flows from the integrated system charging apparatus to the induction chargeable armament.

In addition, the integrated system charging apparatus may manage electrical energy by regulating movement of electrical energy through at least one conduit of the advanced composite material within the integrated system charging apparatus. The conduit may include electrical energy conduction, insulation, restriction, or semi-conduction, within a sub-region or a micro-domain.

The integrated system charging apparatus may regulate movement of thermal energy through at least one conduit of the advanced composite material within the integrated system charging apparatus. The conduit may include thermal energy conduction, insulation, restriction, or controlled-conduction, within a sub-region or a micro-domain.

Wireless energy may be provided by the integrated system charging apparatus wherein a primary induction member of the integrated system charging apparatus is capable of inductively coupling with a secondary induction member of the induction chargeable armament where the secondary induction member is in magnetic flux with a magnetic field proximal to the primary induction member.

Wireless energy may further be provided by the integrated system charging apparatus, wherein an induction energy transmitting unit of the integrated system charging apparatus is manually activated to provide energy to an induction energy receiving unit independent of the existence of compatible electromagnetic field geometry between the primary induction member and the secondary induction member.

Wireless energy may further be provided by the integrated system charging apparatus wherein an induction energy transmitting unit of the integrated system charging apparatus automatically establishes a connection between the induction energy transmitting unit and an induction energy receiving unit; and directs energy between the primary induction member and the secondary induction member.

### Non-Limiting Embodiments

Embodiment 1 is an integrated system charging apparatus comprising a power source, an induction energy transmitting unit, and an electrical conductor; wherein the power source, the induction energy transmitting unit, and the electrical conductor are interconnected; and wherein at least one of the electrical conductor, and the induction energy transmitting unit, further comprises an advanced composite material.

Embodiment 2 is the integrated system charging apparatus of embodiment 1, wherein the integrated system charging apparatus is personally portable.

Embodiment 3 is the integrated system charging apparatus of embodiment 2, wherein the integrated system charging apparatus further comprises a garment comprising an advanced composite material.

Embodiment 4 is the integrated system charging apparatus of embodiment 3, further comprising an induction chargeable armament.

Embodiment 5 is an integrated system charging apparatus comprising a power source, an induction energy transmitting unit, and an electrical conductor; wherein the power source, the induction energy transmitting unit, and the electrical conductor are interconnected; and wherein the induction energy transmitting unit further comprises a primary induction member; wherein at least one of the electrical conductor, the induction energy transmitting unit, and the primary induction member further comprises an advanced composite material; wherein the advanced composite material comprises at least two regions; and wherein a first region of the advanced composite material is an advanced composite material forming an electrical power management region, an advanced composite material forming an electrical power management sub-region, an advanced composite material forming an electrical power management micro domain or combinations thereof; and at least a second region of the advanced composite material is an advanced composite material forming a thermal power management region, an advanced composite material forming a thermal power management sub-region, an advanced composite material forming a thermal power management micro domain or combinations thereof; which in combination provides the integrated system charging apparatus.

Embodiment 6 is the integrated system charging apparatus of embodiment 5, wherein a housing for the induction energy transmitting unit further comprises an advanced composite material.

Embodiment 7 is the integrated system charging apparatus of embodiment 5, wherein the integrated system charging apparatus is personally portable.

Embodiment 8 is the integrated system charging apparatus of embodiment 7, wherein the integrated system charging apparatus is a garment or a personally portable container.

Embodiment 9 is the integrated system charging apparatus of embodiment 8, wherein the garment and the personally portable container comprise an advanced composite material.

Embodiment 10 is the integrated system charging apparatus of embodiment 5, further comprising an induction chargeable armament.

Embodiment 11 is the integrated system charging apparatus of embodiment 10, wherein the armament is an integrated system armament.

Embodiment 12 is a method of wirelessly providing energy to an induction chargeable armament, the method which comprises providing at least one induction chargeable armament capable of receiving an inductive charge; providing at least one integrated system charging apparatus capable of creating an inductive charge; bringing the induction chargeable armament and the integrated system charging apparatus into proximity with each other, such that the inductive charge flows from the integrated system charging apparatus to the induction chargeable armament.

Embodiment 13 is the method of wirelessly providing energy to an induction chargeable armament of embodiment 12, wherein the integrated system charging apparatus capable of creating an inductive charge is personally portable.

Embodiment 14 is the method of wirelessly providing energy to an induction chargeable armament of embodiment 13, wherein the integrated system charging apparatus capable of creating an inductive charge is a garment.

Embodiment 15 is the method of wirelessly providing energy to an induction chargeable armament of embodiment 12, wherein a secondary induction member is in magnetic flux with a magnetic field proximal to a primary induction member.

Embodiment 16 is the method of wirelessly providing energy to an induction chargeable armament of embodiment 15, wherein an induction energy transmitting unit of the integrated system charging apparatus is manually activated to provide energy to an induction energy receiving unit independent of the electromagnetic field geometry between the primary induction member and the secondary induction member.

Embodiment 17 is the method of wirelessly providing energy to an induction chargeable armament of embodiment 15, wherein an induction energy transmitting unit of the integrated system charging apparatus automatically establishes a connection between the induction energy transmitting unit and the induction energy receiving unit; and directs energy between the primary induction member and the secondary induction member.

Embodiment 18 is any one of embodiments 1-17 combined with any one or more embodiments 2-17.

What is claimed is:

1. An integrated system charging apparatus comprising:
a power source,
an induction energy transmitting unit, and
an electrical conductor;
wherein the power source, the induction energy transmitting unit, and the electrical conductor are interconnected; and wherein
at least one of the electrical conductor, and the induction energy transmitting unit, further comprises an advanced composite material.

2. The integrated system charging apparatus of claim 1,
wherein the integrated system charging apparatus is personally portable.

3. The integrated system charging apparatus of claim 2,
wherein the integrated system charging apparatus further comprises a garment comprising an advanced composite material.

4. The integrated system charging apparatus of claim 3, further comprising an induction chargeable armament.

5. An integrated system charging apparatus comprising:
a power source,
an induction energy transmitting unit, and
an electrical conductor;
wherein the power source, the induction energy transmitting unit, and the electrical conductor are interconnected, and wherein
the induction energy transmitting unit further comprises a primary induction member;
wherein
at least one of the electrical conductor, the induction energy transmitting unit, and the primary induction member further comprises an advanced composite material;
wherein
the advanced composite material comprises at least two regions; and wherein
a first region of the advanced composite material is selected from the group consisting of an advanced composite material forming an electrical power management region, an advanced composite material forming an electrical power management sub-region, an advanced composite material forming an electrical power management micro domain and combinations thereof;
and at least a second region of the advanced composite material is selected from the group consisting of an advanced composite material forming a thermal power management region, an advanced composite material forming a thermal power management sub-region, an advanced composite material forming a thermal power management micro domain and combinations thereof;
which in combination provides the integrated system charging apparatus.

6. The integrated system charging apparatus of claim 5, wherein
a housing for the induction energy transmitting unit further comprises an advanced composite material.

7. The integrated system charging apparatus of claim 5, wherein
the integrated system charging apparatus is personally portable.

8. The integrated system charging apparatus of claim 7, wherein
the integrated system charging apparatus is selected from a group consisting of: a garment and a personally portable container.

9. The integrated system charging apparatus of claim 8, wherein
the garment and the personally portable container comprise an advanced composite material.

10. The integrated system charging apparatus of claim 5, further comprising an induction chargeable armament.

11. The integrated system charging apparatus of claim 10, wherein the armament is an integrated system armament.

12. A method of wirelessly providing energy to an induction chargeable armament, the method comprising:
providing at least one induction chargeable armament capable of receiving an inductive charge;
providing at least one integrated system charging apparatus capable of creating an inductive charge;
bringing the induction chargeable armament and the integrated system charging apparatus into proximity with each other, such that the inductive charge flows from the integrated system charging apparatus to the induction chargeable armament.

13. The method of wirelessly providing energy of claim 12,
wherein the integrated system charging apparatus capable of creating an inductive charge is personally portable.

14. The method of wirelessly providing energy of claim 13,
wherein the integrated system charging apparatus capable of creating an inductive charge is a garment.

15. The method of wirelessly providing energy of claim 12,
wherein a secondary induction member is in magnetic flux with a magnetic field proximal to a primary induction member.

16. The method of wirelessly providing energy of claim 15, wherein
an induction energy transmitting unit of the integrated system charging apparatus is manually activated to provide energy to an induction energy receiving unit independent of the electromagnetic field geometry between the primary induction member and the secondary induction member.

17. The method of wirelessly providing energy of claim 15, wherein
an induction energy transmitting unit of the integrated system charging apparatus automatically establishes a connection between the induction energy transmitting unit and the induction energy receiving unit; and directs energy between the primary induction member and the secondary induction member.
